(19) United States
(12) Patent Application Publication
(10) Pub. No.: US 2011/0247756 A1
(43) Pub. Date: Oct. 13, 2011

(54) HOMOGENEOUS BISMALEIMIDE - TRIAZINE - EPOXY COMPOSITIONS USEFUL FOR THE MANUFACTURE OF ELECTRICAL LAMINATES

(75) Inventors: Mark B. Wilson, Clute, TX (US); Donde R. Anderson, Woodridge, IL (US)

(73) Assignee: DOW GLOBAL TECHNOLOGIES LLC, Midland, MI (US)

(21) Appl. No.: 13/133,874

(22) PCT Filed: Dec. 11, 2009
(86) PCT No.: PCT/US09/67753

§ 371 Date: Jun. 9, 2011

Related U.S. Application Data
(60) Provisional application No. 61/122,882, filed on Dec. 16, 2008.

(51) Int. Cl. B29C 70/88; C08L 63/10

(52) U.S. Cl. 156/307.7; 525/530

(57) ABSTRACT

Homogeneous solutions including an epoxy resin, a maleimide component including at least one bismaleimide, and a cyanate ester component are disclosed. Such compositions may be useful, for example, in curable compositions, thermoset compositions, and the manufacture of electrical laminates and other end products that may be formed from or using the curable and thermoset compositions.

### BACKGROUND

1. Field of the Invention

Embodiments disclosed herein relate to epoxy compositions useful in electrical laminates. More specifically, embodiments disclosed herein relate to bismaleimide-modified epoxy compositions useful in electrical laminates, having improved formulation homogeneity while maintaining or improving key properties.

2. Background

Thermosettable materials useful in high-performance electrical applications, such as high-performance circuit boards, must meet a set of demanding property requirements. For example, such materials optimally have good high-temperature properties such as high glass transition temperatures (e.g., above 200° C.) and low water absorption at elevated temperature (e.g., less than 0.5% water adsorption). The components used in the thermoset formulation materials must also exhibit stable solubility in organic solvents, such as acetone, 2-butanone, or cyclohexanone, as the preparation of electrical laminates conventionally involves impregnation of a porous glass web with a solution of the thermosettable resin to form prepregs. For ease of processing in preparing prepregs for composite parts, the uncured blend will ideally have a low melting temperature (e.g., below 120° C.) and a wide temperature range of processable viscosity (a wide “processing window”).

Epoxy resins are one of the most widely used engineering resins, and are well-known for their use in electrical laminates. Epoxy resins have been used as materials for electrical/electronic equipment, such as materials for electrical laminates because of their superiority in heat resistance, chemical resistance, insulation property, dimensional stability, adhesiveness and the like.

Bismaleimide-modified epoxy resins have good high-temperature properties, making them excellent candidates for use in electrical laminates. Bismaleimides, however, are typically quite brittle and they are not readily soluble in inexpensive organic solvents. As a result, the bismaleimide component is typically incorporated into formulations as a particulate in suspension. Over time, the suspended particles tend to separate, thereby requiring agitation of the formulation prior to use.

Accordingly, there exists a need for bismaleimide-modified compositions, useful in electrical laminates, where the compositions are stable, homogeneous, and inexpensive to produce.

### SUMMARY OF INVENTION

In one aspect, embodiments disclosed herein relate to a process for forming a curable composition, including: admixing an epoxy resin and a maleimide component comprising at least one bismaleimide at a temperature in the range from about 50° C. to about 250° C.; and admixing a cyanate ester component with the epoxy-maleimide admixture to form a homogeneous solution.

In another aspect, embodiments disclosed herein relate to a curable composition, including: a maleimide component comprising at least one bismaleimide; a cyanate ester component; and an epoxy resin; wherein the curable composition is a homogeneous solution.

In another aspect, embodiments disclosed herein relate to a lacquer for use in electrical laminates, the lacquer including a curable composition including: a maleimide component comprising at least one bismaleimide; a cyanate ester component; and an epoxy resin; wherein the curable composition is a homogeneous solution.

In another aspect, embodiments disclosed herein relate to a thermoset composition, including a reaction product of a homogeneous curable composition including a cyanate ester, an epoxy resin, and a maleimide component comprising at least one bismaleimide. Such thermoset compositions may be used to form various composites and other products.

In another aspect, embodiments disclosed herein relate to a process for forming a composite, including: impregnating a first substrate with a curable composition, wherein the curable composition includes: a maleimide component comprising at least one bismaleimide; a cyanate ester component; and an epoxy resin; wherein the curable composition is a homogeneous solution; at least partially curing the curable composition to form a prepreg; disposing the prepreg on a second substrate; and curing the prepreg to form an electrical laminate.

Other aspects and advantages of the invention will be apparent from the following description and the appended claims.

### DETAILED DESCRIPTION

In one aspect, embodiments disclosed herein relate generally to epoxy compositions useful in electrical laminates. In another aspect, embodiments disclosed herein relate to bismaleimide-modified epoxy compositions. More specifically, embodiments disclosed herein relate to bismaleimide-modified epoxy compositions useful in electrical laminates and having improved formulation homogeneity.

In other aspects, embodiments disclosed herein relate to curable compositions useful in varnishes for electrical laminate applications, including a maleimide component comprising, consisting of, or consisting essentially of at least one bismaleimide, at least one epoxy resin, and at least one cyanate ester component. Embodiments of such compositions have been found to be stable, homogeneous, and inexpensive to produce. For example, prior curable compositions useful in varnishes incorporated maleimides as particulates in suspension. In one aspect, embodiments disclosed herein relate to curable compositions where the maleimide components have improved solubility, thereby improving the homogeneity of the compositions.

In some embodiments, the maleimide component used in the curable compositions disclosed herein may be a blend of two or more maleimides including a bismaleimide component, such as 4,4′-bismaleimido-diphenylmethane. It has been found that blended maleimide compositions according to embodiments disclosed herein may be incorporated into epoxy resin compositions, where the resulting curable composition maintains formulation homogeneity for extended periods of time, such as greater than 4 weeks.

In one embodiment, the blended maleimide component may be a mixture of N-phenyl maleimide and 4,4′-bismaleimido-diphenylmethane, where at a weight ratio of the N-phenyl maleimide to the 4,4′-bismaleimido-diphenylmethane may range from 95:5 to 5:95 when present together. In other embodiments, the N-phenyl maleimide and 4,4′-bismaleimido-diphenylmethane may be blended at a weight ratio from 25:75 to 75:25 when present together. In still other embodiments, the N-phenyl maleimide and 4,4′-bismaleimido-diphenylmethane may be blended at a weight ratio from 35:65 to 65:35 when present together.

In some embodiments, the maleimide epoxy composition may contain a cyanate ester or a partially trimerized cyanate ester. In one embodiment, curable compositions disclosed herein may include maleimides, epoxy resins, and cyanate ester components where the molar ratios of the maleimide, epoxy resin, and cyanate ester components, based on their respective functional groups, may range from 90:5:5 to 5:90:5 to 5:5:90, respectively, or any combination of ratios in between such values. In other embodiments, the relative molar ratios of the maleimide, epoxy resin, and cyanate ester components, based on their respective functional groups, may be from 30:20:50 to 50:30:20 to 20:50:30. A particular embodiment may have a relative molar ratio of 37:23:40 (maleimide:epoxy:cyanate ester).

In other aspects, embodiments disclosed herein relate to a process for the formation of a curable composition useful as a varnish in an electrical laminate. The process may include one or more of: preparing a maleimide blend, preparing cyanate esters, and preparing a thermoset resin composition including the maleimide blend, cyanate esters, and epoxy resins. In other aspects, embodiments disclosed herein relate to using the above described composition in composites, coatings, adhesives, or sealants that may be disposed on, in, or between various substrates.

In some embodiments, the curable compositions disclosed herein may be formed by admixing maleimides and epoxy resins at an elevated temperature to form a homogeneous composition. The process may further include admixing cyanate esters with the homogeneous composition to form curable compositions. In other embodiments, maleimides, epoxy resins, and cyanate esters may be admixed at an elevated temperature to form a homogeneous curable composition. In some embodiments, the maleimides and epoxy resins may be incorporated at an elevated temperature, such as in the range from about 30° C. to about 280° C. In other embodiments, the maleimides and epoxy resins may be incorporated at a temperature in the range from 50° C. to 250° C. In yet other embodiments, the maleimides and epoxy resins may be incorporated at a temperature in the range from 70° C. to 180° C., or even from 120° C. to 140° C. In still other embodiments, additional components may be admixed with the maleimides and epoxy resins at the elevated temperatures described above. In other embodiments, additional components may be admixed, at an appropriate temperature, such as room temperature or above, with the mixture resulting from the admixture of the maleimide components and the epoxy resins.

In some aspects, embodiments disclosed herein relate to curable compositions having improved ease-of-use, formulation homogeneity, and clarity. For example, it has been found that admixture of a bismaleimide with other maleimide components may result in improved solubility of the bismaleimide in epoxy resins and solvent. Such improvements may result in complete or near complete dissolution of the bismaleimide in the curable compositions, thus resulting in formulation homogeneity and improved clarity of the solution. Further, due to the dissolution, the resulting curable compositions will not settle, as for bismaleimide suspensions, resulting in improved ease-of-use due (absence of mixing and other steps that are often required where a suspension has settled). In yet other aspects, embodiments disclosed herein relate to curable compositions that maintain or improve key performance attributes (e.g., allowing for a relatively high glass transition temperature with a higher decomposition temperature for the cured composition).

In some aspects, the components of the curable compositions disclosed herein may be reacted in the presence of a catalyst, and optionally may be reacted with a hardener or curing agent to form partially cured products or cured products, including thermoset resins having bismaleimide-triazine-epoxy functionalities.

In further aspects, the electrical laminate composition may be a self-curing composition at low to moderate temperatures. In still further aspects, the electrical laminate may be cured using external heating.

As described above, embodiments disclosed herein include various components, such as maleimides, epoxy resins, and cyanate esters, or partially trimerized cyanate esters. Embodiments of compositions described herein may also include other components, such as catalysts, free flame retardants, co-curing agents, synergists, solvents, particulate fillers, adhesion promoters, wetting and dispersing aids, air release additives, surface modifiers, thermoplastic resins, mold release agents, other functional additives or prereacted products to improve polymer properties, isocyanates, isocyanurates, allyl containing molecules or other ethylenically unsaturated compounds, and acrylates. Examples of each of these components are described in more detail below.

Maleimide

Curable compositions disclosed herein may include, but are not limited to, as noted above, an admixture of maleimides with bismaleimides, such as an admixture of phenyl maleimide with 4,4′-bismaleimido-diphenylmethane. The use of these blended maleimide compositions has been found to result in improved solubility of bismaleimides within the curable compositions, which may result in the curable composition being a homogeneous solution.

Maleimide monomers suitably employed in embodiments disclosed herein include, but are not limited to, maleimide, N-alkylmaleimide and N-arylmaleimide compounds including N-phenylmaleimide. In N-arylmaleimides, the aryl substituent may have one or more of the atoms replaced by other inert moieties such as halo or lower alkyl. Suitable N-arylmaleimides are disclosed in U.S. Pat. No. 3,652,726, the teachings of which are incorporated herein by reference. Aryl groups that may be present in the N-arylmaleimides include, for example, phenyl, 4-diphenyl, 1-naphthyl, all the mono- and di-methylphenyl isomers, 2,6-diethylphenyl, 2-, 3- and 4-chlorophenyl, 4-bromophenyl and other mono- and di-halophenyl isomers, 2,4,6-trichlorophenyl, 2,4,6-tribromophenyl, 4-n-butylphenyl, 2-methyl-4-n-butylphenyl, 4-benzylphenyl, 2-, 3- and 4-methoxyphenyl, 2-methoxy-5-chlorophenyl, 2-methoxy-5-bromophenyl, 2,5-dimethoxy-4-chlorophenyl, 2-, 3- and 4-ethoxyphenyl, 2,5-diethoxyphenyl, 4-phenoxyphenyl, 4-methoxycarbonylphenyl, 4-cyanophenyl, 2,5- and 4-nitrophenyl and methyl-chlorophenyl (2,3-, 2,4-, 2,5- and 4,3-isomers). An exemplary N-arylmaleimide monomer is N-phenylmaleimide. Mixtures of maleimide monomers may be employed.

N-substituted maleimide monomers suitable for use herein include, but are not limited to, N-alkylmaleimides such as N-methylmaleimide, N-ethylmaleimide, N-propylmaleimide, N-isopropylmaleimide, N-t-butylmaleimide, etc.; N-cycloakylmaleimides such as N-cyclohexylmaleimide; N-arylmaleimides such as N-phenylmaleimide, N-naphthylmaleimide.

Bismaleimide resins may include 4,4′-bismaleimido-diphenylmethane, 1,4-bismaleimido-2-methylbenzene and mixtures thereof; modified and partially advanced modified bismaleimide resins containing Diels-Alder comonomers; and a partially advanced bismaleimide based on 4,4′-bismaleimido-diphenylmethane and allylphenyl compounds or aromatic amines. Examples of suitable Diels-Alder comonomers include styrene and styrene derivatives, bis(propenylphenoxy) compounds, 4,4′-bis(propenylphenoxy)sulfones, 4,4′-bis(propenylphenoxy)benzophenones and 4,4′-1-(1-methyl ethylidene) bis(2-(2-propenyl)phenol). Examples of commercially available modified bismaleimides based on 4,4′-bismaleimido-diphenylmethane and an allylphenyl compound, such as diallylbisphenol-A, are MATRIMID 5292A and MATRIMID 5292B from Huntsman Corporation. Other bismaleimides include Michael addition copolymers of bismaleimide and aromatic diamines, such as 4,4′-bismaleimido-diphenylmethane/4,4′-diaminodiphenylmethane. Still other bismaleimides are higher molecular weight bismaleimides produced by advancement reactions of the aforementioned bismaleimide resins. Exemplary bismaleimide resins are those based on 4,4′-bismaleimido-diphenylmethane.

With regard to bismaleimide compounds, BMI-S (4,4′-diphenylmethane bismaleimide; available from Mitsui Chemicals, Inc.), and BMI-M-20 (polyphenylmethane maleimide; also available from Mitsui Chemicals, Inc.), may be exemplified.

Cyanate Ester

Cyanate ester resins comprise cyanate ester compounds (monomers and oligomers) each having two or more —OCN functional groups, and typically having a cyanate equivalent weight of from about 50 to about 500. The molecular weight of the monomers and oligomers are typically from about 150 to about 2000.

Embodiments disclosed herein include one or more cyanate esters according to Formulas I, II, III or IV. Formula I is represented by the formula Q(OCN)ₚ, where p ranges from 2 to 7, and where Q includes at least one of the following categories: (1) a mono-, di-, tri-, or tetra-substituted aromatic hydrocarbon including from about 5 to about 30 carbon atoms, and (2) a 1 to 5 aliphatic or polycyclic aliphatic mono-, di-, tri- or tetra-substituted hydrocarbon including from about 7 to about 20 carbon atoms. Optionally, either category may include from about 1 to about 10 heteroatoms selected from non-peroxidic oxygen, sulfur, non-phosphino phosphorous, non-amino nitrogen, halogen, and silicon. Formula II is represented by:

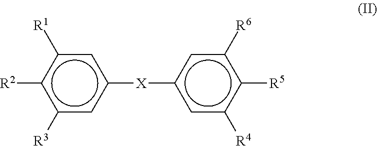

In Formula II, X is a single bond, a lower alkylene group having from 1 to 4 carbons, —S—, or the SO₂ group; and where R¹, R², R³, R⁴, R⁵, and R⁶ are independently hydrogen, an alkyl group having from one to three carbon atoms, or the cyanate ester group (—OC≡N), with the proviso that at least two of R¹, R², R³, R⁴, R⁵, and R⁶ are cyanate ester groups. In exemplary compounds, each of the R groups is either —H, methyl or the cyanate ester group.

Formula III is represented by:

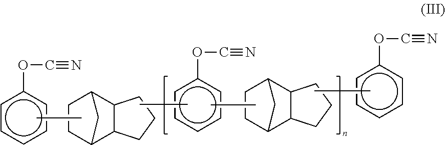

In Formula III, n is from 0 to about 5.

Formula IV is represented by:

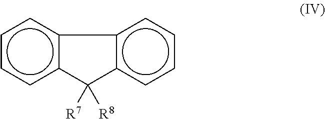

In Formula IV, R⁷ and R⁸ are each independently represented by:

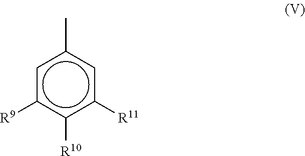

R⁹, R¹⁰, R¹¹ are independently —H, a lower alkyl group having from about 1 to about 5 carbon atoms, or the cyanate ester group, preferably hydrogen, methyl or the cyanate ester group, with the proviso that R⁷, and R⁸ combined include at least two cyanate ester groups.

Useful cyanate ester compounds include, but are not limited to the following: 1,3- and 1,4-dicyanatobenzene; 2-tert-butyl-1,4-dicyanatobenzene; 2,4-dimethyl-1,3-dicyanatobenzene; 2,5-di-tert-butyl-1,4-dicyanatobenzene; tetramethyl-1,4-dicyanatobenzene; 4-chloro-1,3-dicyanatobenzene; 1,3,5-tricyanatobenzene; 2,2′- and 4,4′-dicyanatobiphenyl; 3,3′5,5′-tetramethyl-4,4′-dicyanatobiphenyl; 1,3-, 1,4-, 1,5-, 1,6-, 1,8-, 2,6-, and 2,7-dicyanatonaphthalene; 1,3,6-tricyanatonaphthalene; bis(4-cyanatophenyl)methane; bis(3-chloro-4-cyanatophenyl)methane; bis(3,5-dimethyl-4-cyanatophenyl)methane; 1,1-bis(4-cyanatophenyl)ethane; 2,2-bis(4-cyanatophenyl)propane; 2,2-bis(3,3-dibromo-4-cyanatophenyl)propane; 2,2-bis(4-cyanatophenyl)-1,1,1,3,3,3-hexafluoropropane; bis(4-cyanatophenyl)ester; bis(4-cyanatophenoxy)benzene; bis(4-cyanatophenyl)ketone; bis(4-cyanatophenyl)thioether; bis(4-cyanatophenyl)sulfone; tris(4-cyanatophenyl)phosphate, and tris(4-cyanatophenyl)phosphate.

Also useful are cyanic acid esters derived from phenolic resins, e.g., as disclosed in U.S. Pat. No. 3,962,184, cyanated novolac resins derived from novolac, e.g., as disclosed in U.S. Pat. No. 4,022,755, cyanated bis-phenol-type polycarbonate oligomers derived from bisphenol-type polycarbonate oligomers, as disclosed in U.S. Pat. No. 4,026,913, cyano-terminated polyarylene ethers as disclosed in U.S. Pat. No. 3,595,900, and dicyanate esters free of ortho hydrogen atoms as disclosed in U.S. Pat. No. 4,740,584, mixtures of di- and tricyanates as disclosed in U.S. Pat. No. 4,709,008, polyaromatic cyanates containing polycyclic aliphatic groups as disclosed in U.S. Pat. No. 4,528,366, e.g., QUATREX 7187, formerly available from The Dow Chemical Company, Midland, Mich., fluorocarbon cyanates as disclosed in U.S. Pat. No. 3,733,349, and cyanates disclosed in U.S. Pat. Nos. 4,195,132, and 4,116,946, all of the foregoing patents being incorporated by reference.

Polycyanate compounds obtained by reacting a phenol-formaldehyde precondensate with a halogenated cyanide are also useful.

Exemplary cyanate ester compositions include low molecular weight oligomers, e.g., from about 250 to about 1200, of bisphenol-A dicyanates, such as AROCY BC-30 Cyanate Ester Semisolid Resin; low molecular weight oligomers of tetra o-methyl bisphenol F dicyanates, such as AROCY M-30 Cyanate Ester Semisolid Resin; low molecular weight oligomers of thiodiphenol dicyanates, such as AROCY T-30, all of which are commercially available from Huntsman Advance Materials, Switzerland.

Examples of cyanate ester compounds include PRIMASET BA200, which is a cyanate ester of a bisphenol A type (manufactured by Lonza Corporation); PRIMASET BA 230 S (manufactured by Lonza Corporation); PRIMASET LECY, which is a cyanate ester of a bisphenol H type (manufactured by Lonza Corporation); AROCY L 10 (manufactured by Huntsman Advance Materials, Switzerland); PRIMASET PT 30, which is a cyanate ester of a novolak type (manufactured by Lonza Corporation); AROCY XU-371 (manufactured by Huntsman Advance Materials, Switzerland); and AROCY XP 71787.02L, which is a cyanate ester of a dicyclopentadiene type (manufactured by Huntsman Advance Materials, Switzerland) may be exemplified.

Mixtures of any of the above-listed cyanate esters may, of course, also be used.

Epoxy Resins

The epoxy resins used in embodiments disclosed herein may vary and include conventional and commercially available epoxy resins, which may be used alone or in combinations of two or more, including, for example, novalac resins, isocyanate modified epoxy resins, and carboxylate adducts, among others. In choosing epoxy resins for compositions disclosed herein, consideration should not only be given to properties of the final product, but also to viscosity and other properties that may influence the processing of the resin composition.

The epoxy resin component may be any type of epoxy resin useful in molding compositions, including any material containing one or more reactive oxirane groups, referred to herein as “epoxy groups” or “epoxy functionality.” Epoxy resins useful in embodiments disclosed herein may include mono-functional epoxy resins, multi- or poly-functional epoxy resins, and combinations thereof. Monomeric and polymeric epoxy resins may be aliphatic, cycloaliphatic, aromatic, or heterocyclic epoxy resins. The polymeric epoxies include linear polymers having terminal epoxy groups (a diglycidyl ether of a polyoxyalkylene glycol, for example), polymer skeletal oxirane units (polybutadiene polyepoxide, for example) and polymers having pendant epoxy groups (such as a glycidyl methacrylate polymer or copolymer, for example). The epoxies may be pure compounds, but are generally mixtures or compounds containing one, two or more epoxy groups per molecule. In some embodiments, epoxy resins may also include reactive —OH groups, which may react at higher temperatures with anhydrides, organic acids, amino resins, phenolic resins, or with epoxy groups (when catalyzed) to result in additional crosslinking.

In general, the epoxy resins may be glycidated resins, cycloaliphatic resins, epoxidized oils, and so forth. The glycidated resins are frequently the reaction product of a glycidyl ether, such as epichlorohydrin, and a bisphenol compound such as bisphenol A; C₄ to C₂₈ alkyl glycidyl ethers; C₂ to C₂₈ alkyl- and alkenyl-glycidyl esters; C₁ to C₂₈ alkyl-, mono- and poly-phenol glycidyl ethers; polyglycidyl ethers of polyvalent phenols, such as pyrocatechol, resorcinol, hydroquinone, 4,4′-dihydroxydiphenyl methane (or bisphenol F), 4,4′-dihydroxy-3,3′-dimethyldiphenyl methane, 4,4′-dihydroxydiphenyl dimethyl methane (or bisphenol A), 4,4′-dihydroxydiphenyl methyl methane, 4,4′-dihydroxydiphenyl cyclohexane, 4,4′-dihydroxy-3,3′-dimethyldiphenyl propane, 4,4′-dihydroxydiphenyl sulfone, and tris(4-hydroxyphynyl)methane; polyglycidyl ethers of the chlorination and bromination products of the above-mentioned diphenols; polyglycidyl ethers of novolacs; polyglycidyl ethers of diphenols obtained by esterifying ethers of diphenols obtained by esterifying salts of an aromatic hydrocarboxylic acid with a dihaloalkane or dihalogen dialkyl ether; polyglycidyl ethers of polyphenols obtained by condensing phenols and long-chain halogen paraffins containing at least two halogen atoms. Other examples of epoxy resins useful in embodiments disclosed herein include bis-4,4′-(1-methylethylidene) phenol diglycidyl ether and (chloromethyl) oxirane bisphenol A diglycidyl ether.

In some embodiments, the epoxy resin may include glycidyl ether type; glycidyl-ester type; alicyclic type; heterocyclic type, and halogenated epoxy resins, etc. Non-limiting examples of suitable epoxy resins may include cresol novolac epoxy resin, phenolic novolac epoxy resin, biphenyl epoxy resin, hydroquinone epoxy resin, stilbene epoxy resin, and mixtures and combinations thereof.

Suitable polyepoxy compounds may include resorcinol diglycidyl ether (1,3-bis-(2,3-epoxypropoxy)benzene), diglycidyl ether of bisphenol A (2,2-bis(p-(2,3-epoxypropoxy)phenyl)propane), triglycidyl p-aminophenol (4-(2,3-epoxypropoxy)-N,N-bis(2,3-epoxypropyl)aniline), diglycidyl ether of bromobispehnol A (2,2-bis(4-(2,3-epoxypropoxy)-3-bromo-phenyl)propane), diglydicylether of bisphenol F (2,2-bis(p-(2,3-epoxypropoxy)phenyl)methane), triglycidyl ether of meta- and/or para-aminophenol (3-(2,3-epoxypropoxy)N,N-bis(2,3-epoxypropyl)aniline), and tetraglycidyl methylene dianiline (N,N,N′,N′-tetra(2,3-epoxypropyl) 4,4′-diaminodiphenyl methane), and mixtures of two or more polyepoxy compounds. A more exhaustive list of useful epoxy resins found may be found in Lee, H. and Neville, K., Handbook of Epoxy Resins, McGraw-Hill Book Company, 1982 reissue.

Other suitable epoxy resins include polyepoxy compounds based on aromatic amines and epichlorohydrin, such as N,N′-diglycidyl-aniline; N,N′-dimethyl-N,N′-diglycidyl-4,4′-diaminodiphenyl methane; N,N,N′,N′-tetraglycidyl-4,4′-diaminodiphenyl methane; N-diglycidyl-4-aminophenyl glycidyl ether; and N,N,N′,N′-tetraglycidyl-1,3-propylene bis-4-aminobenzoate. Epoxy resins may also include glycidyl derivatives of one or more of aromatic diamines, aromatic monoprimary amines, aminophenols, polyhydric phenols, polyhydric alcohols, polycarboxylic acids.

Useful epoxy resins include, for example, polyglycidyl ethers of polyhydric polyols, such as ethylene glycol, triethylene glycol, 1,2-propylene glycol, 1,5-pentanediol, 1,2,6-hexanetriol, glycerol, and 2,2-bis(4-hydroxy cyclohexyl)propane; polyglycidyl ethers of aliphatic and aromatic polycarboxylic acids, such as, for example, oxalic acid, succinic acid, glutaric acid, terephthalic acid, 2,6-napthalene dicarboxylic acid, and dimerized linoleic acid; polyglycidyl ethers of polyphenols, such as, for example, bis-phenol A, bis-phenol F, 1,1-bis(4-hydroxyphenyl)ethane, 1,1-bis(4-hydroxyphenyl)isobutane, and 1,5-dihydroxy napthalene; modified epoxy resins with acrylate or urethane moieties; glycidlyamine epoxy resins; and novolac resins.

The epoxy compounds may be cycloaliphatic or alicyclic epoxides. Examples of cycloaliphatic epoxides include diepoxides of cycloaliphatic esters of dicarboxylic acids such as bis(3,4-epoxycyclohexylmethyl)oxalate, bis(3,4-epoxycyclohexylmethyl)adipate, bis(3,4-epoxy-6-methylcyclohexylmethyl)adipate, bis(3,4-epoxycyclohexylmethyl)pimelate; vinyl cyclohexene diepoxide; limonene diepoxide; dicyclopentadiene diepoxide; and the like. Other suitable diepoxides of cycloaliphatic esters of dicarboxylic acids are described, for example, in U.S. Pat. No. 2,750,395.

Other cycloaliphatic epoxides include 3,4-epoxycyclohexylmethyl-3,4-epoxycyclohexane carboxylates such as 3,4-epoxycyclohexylmethyl-3,4-epoxycyclohexane carboxylate; 3,4-epoxy-1-methylcyclohexyl-methyl-3,4-epoxy-1-methylcyclohexane carboxylate; 6-methyl-3,4-epoxycyclohexylmethylmethyl-6-methyl-3,4-epoxycyclohexane carboxylate; 3,4-epoxy-2-methylcyclohexylmethyl-3,4-epoxy-2-methylcyclohexane carboxylate; 3,4-epoxy-3-methylcyclohexyl-methyl-3,4-epoxy-3-methylcyclohexane carboxylate; 3,4-epoxy-5-methylcyclohexyl-methyl-3,4-epoxy-5-methylcyclohexane carboxylate and the like. Other suitable 3,4-epoxycyclohexylmethyl-3,4-epoxycyclohexane carboxylates are described, for example, in U.S. Pat. No. 2,890,194.

Further epoxy-containing materials which are particularly useful include those based on glycidyl ether monomers. Examples are di- or polyglycidyl ethers of polyhydric phenols obtained by reacting a polyhydric phenol with an excess of chlorohydrin such as epichlorohydrin. Such polyhydric phenols include resorcinol, bis(4-hydroxyphenyl)methane (known as bisphenol F), 2,2-bis(4-hydroxyphenyl)propane (known as bisphenol A), 2,2-bis(4′-hydroxy-3′,5′-dibromophenyl)propane, 1,1,2,2-tetrakis(4′-hydroxy-phenyl)ethane or condensates of phenols with formaldehyde that are obtained under acid conditions such as phenol novolacs and cresol novolacs. Examples of this type of epoxy resin are described in U.S. Pat. No. 3,018,262. Other examples include di- or polyglycidyl ethers of polyhydric alcohols such as 1,4-butanediol, or polyalkylene glycols such as polypropylene glycol and di- or polyglycidyl ethers of cycloaliphatic polyols such as 2,2-bis(4-hydroxycyclohexyl)propane. Other examples are monofunctional resins such as cresyl glycidyl ether or butyl glycidyl ether.

Another class of epoxy compounds are polyglycidyl esters and poly(beta-methylglycidyl) esters of polyvalent carboxylic acids such as phthalic acid, terephthalic acid, tetrahydrophthalic acid or hexahydrophthalic acid. A further class of epoxy compounds are N-glycidyl derivatives of amines, amides and heterocyclic nitrogen bases such as N,N-diglycidyl aniline, N,N-diglycidyl toluidine, N,N,N′,N′-tetraglycidyl bis(4-aminophenyl)methane, triglycidyl isocyanurate, N,N′-diglycidyl ethyl urea, N,N′-diglycidyl-5,5-dimethylhydantoin, and N,N′-diglycidyl-5-isopropylhydantoin.

Still other epoxy-containing materials are copolymers of acrylic acid esters of glycidol such as glycidylacrylate and glycidylmethacrylate with one or more copolymerizable vinyl compounds. Examples of such copolymers are 1:1 styrene-glycidylmethacrylate, 1:1 methyl-methacrylateglycidylacrylate and a 62.5:24:13.5 methylmethacrylate-ethyl acrylate-glycidylmethacrylate.

Epoxy compounds that are readily available include octadecylene oxide; glycidylmethacrylate; diglycidyl ether of bisphenol A; D.E.R.™ 331 (bisphenol A liquid epoxy resin) and D.E.R.™ 332 (diglycidyl ether of bisphenol A) available from The Dow Chemical Company, Midland, Mich.; vinylcyclohexene dioxide; 3,4-epoxycyclohexylmethyl-3,4-epoxycyclohexane carboxylate; 3,4-epoxy-6-methylcyclohexyl-methyl-3,4-epoxy-6-methylcyclohexane carboxylate; bis(3,4-epoxy-6-methylcyclohexylmethyl) adipate; bis(2,3-epoxycyclopentyl)ether; aliphatic epoxy modified with polypropylene glycol; dipentene dioxide; epoxidized polybutadiene; silicone resin containing epoxy functionality; flame retardant epoxy resins (such as a brominated bisphenol type epoxy resin available under the trade names D.E.R.™ 580, available from The Dow Chemical Company, Midland, Mich.); polyglycidyl ether of phenolformaldehyde novolac (such as those available under the tradenames D.E.N.™ 431 and D.E.N.™ 438 available from The Dow Chemical Company, Midland, Mich.); and resorcinol diglycidyl ether. Although not specifically mentioned, other epoxy resins under the tradename designations D.E.R.™ and D.E.N.™ available from The Dow Chemical Company may also be used.

Epoxy resins may also include isocyanate modified epoxy resins. Polyepoxide polymers or copolymers with isocyanate or polyisocyanate functionality may include epoxy-polyurethane copolymers. These materials may be formed by the use of a polyepoxide prepolymer having one or more oxirane rings to give a 1,2-epoxy functionality and also having open oxirane rings, which are useful as the hydroxyl groups for the dihydroxyl-containing compounds for reaction with diisocyanate or polyisocyanates. The isocyanate moiety opens the oxirane ring and the reaction continues as an isocyanate reaction with a primary or secondary hydroxyl group. There is sufficient epoxide functionality on the polyepoxide resin to enable the production of an epoxy polyurethane copolymer still having effective oxirane rings. Linear polymers may be produced through reactions of diepoxides and diisocyanates. The di- or polyisocyanates may be aromatic or aliphatic in some embodiments. Epoxy—isocyanate copolymers resulting in isocyanurate linkages are can also be used.

Other suitable epoxy resins are disclosed in, for example, U.S. Pat. Nos. 7,163,973, 6,632,893, 6,242,083, 7,037,958, 6,572,971, 6,153,719, and 5,405,688 and U.S. Patent Application Publication Nos. 20060293172 and 20050171237, each of which is hereby incorporated herein by reference.

Mixtures of any of the above-listed epoxy resins may, of course, also be used.

Solvents

Another component, which may be added to the curable compositions, is a solvent or a blend of solvents. The solvent used in the epoxy resin composition may be miscible with the other components in the resin composition. The solvent used may be selected from those typically used in making electrical laminates. Examples of suitable solvents employed in the present invention include, for example, ketones, ethers, acetates, aromatic hydrocarbons, cyclohexanone, dimethylformamide, glycol ethers, and combinations thereof.

Solvents for the catalyst and the inhibitor may include polar solvents. Lower alcohols having from 1 to 20 carbon atoms, such as, for example, methanol, provide good solubility and volatility for removal from the resin matrix when prepregs are formed. Other useful solvents may include, for example, acetone, methyl ethyl ketone, DOWANOL™ PMA, DOWANOL™ PM, N,-methyl-2-pyrrolidone, dimethylsul foxide, dimethylformamide, tetrahydrofuran, 1,2-propane diol, ethylene glycol and glycerine.

The total amount of solvent used in the curable epoxy resin composition generally may range from about 1 to about 65 weight percent in some embodiments. In other embodiments, the total amount of solvent may range from 2 to 60 weight percent; from 3 to 50 weight percent in other embodiments; and from 5 to 40 weight percent in yet other embodiments.

Mixtures of one or more of the above described solvents may also be used.

Catalysts

Optionally, catalysts may be added to the curable compositions described above. Catalysts may include, but are not limited to, imidazole compounds including compounds having one imidazole ring per molecule, such as imidazole, 2-methylimidazole, 2-ethyl-4-methylimidazole, 2-undecylimidazole, 2-heptadecylimidazole, 2-phenylimidazole, 2-phenyl-4-methylimidazole, 1-benzyl-2-methylimidazole, 2-ethylimidazole, 2-isopropylimidazole, 2-phenyl-4-benzylimidazole, 1-cyanoethyl-2-methylimidazole, 1-cyanoethyl-2-ethyl-4-methylimidazole, 1-cyanoethyl-2-undecylimidazole, 1-cyanoethyl-2-isopropylimidazole, 1-cyanoethyl-2-phenylimidazole, 2,4-diamino-6-[2′-methylimidazolyl-(1)′]-ethyl-s-triazine, 2,4-diamino-6-[2′-ethyl-4-methylimidazolyl-(1)′]-ethyl-s-triazine, 2,4-diamino-6-[2′-undecylimidazolyl-(1)′]-ethyl-s-triazine, 2-methyl-imidazo-lium-isocyanuric acid adduct, 2-phenylimidazolium-isocyanuric acid adduct, 1-aminoethyl-2-methylimidazole, 2-phenyl-4,5-dihydroxymethylimidazole, 2-phenyl-4-methyl-5-hydroxymethylimidazole, 2-phenyl-4-benzyl-5-hydroxymethylimidazole and the like; and compounds containing 2 or more imidazole rings per molecule which are obtained by dehydrating above-named hydroxymethyl-containing imidazole compounds such as 2-phenyl-4,5-dihydroxymethylimidazole, 2-phenyl-4-methyl-5-hydroxymethylimidazole and 2-phenyl-4-benzyl-5-hydroxy-methylimidazole; and condensing them with formaldehyde, e.g., 4,4′-methylene-bis-(2-ethyl-5-methylimidazole), and the like.

In other embodiments, suitable catalysts may include amine catalysts such as N-alkylmorpho lines, N-alkylalkanolamines, N,N-dialkylcyclohexylamines, and alkylamines where the alkyl groups are methyl, ethyl, propyl, butyl and isomeric forms thereof, and heterocyclic amines.

Non-amine catalysts may also be used. Organometallic compounds of bismuth, lead, tin, titanium, iron, antimony, uranium, cadmium, cobalt, thorium, aluminum, mercury, zinc, nickel, cerium, molybdenum, vanadium, copper, manganese, and zirconium, may be used. Illustrative examples include bismuth nitrate, lead 2-ethylhexoate, lead benzoate, ferric chloride, antimony trichloride, stannous acetate, stannous octoate, and stannous 2-ethylhexoate. Other catalysts that may be used are disclosed in, for example, PCT Publication No. WO 00/15690, which is incorporated by reference in its entirety.

In some embodiments, suitable catalysts may include nucleophilic amines and phosphines, especially nitrogen heterocycles such as alkylated imidazoles: 2-phenyl imidazole, 2-methyl imidazole, 1-methyl imidazole, 2-methyl-4-ethyl imidazole; other heterocycles such as diazabicycloundecene (DBU), diazabicyclooctene, hexamethylenetetramine, morpholine, piperidine; trialkylamines such as triethylamine, trimethylamine, benzyldimethyl amine; phosphines such as triphenylphosphine, tritolylphosphine, triethylphosphine; quaternary salts such as triethylammonium chloride, tetraethylammonium chloride, tetraethylammonium acetate, triphenylphosphonium acetate, and triphenylphosphonium iodide.

Mixtures of one or more of the above described catalysts may also be used.

Epoxy Hardeners/Curing Agents

A hardener or curing agent may be provided for promoting crosslinking of the curable composition to form a thermoset composition. The hardeners and curing agents may be used individually or as a mixture of two or more. In some embodiments, hardeners may include dicyandiamide (dicy) or phenolic curing agents such as novolacs, resoles, bisphenols. Other hardeners may include advanced (oligomeric) epoxy resins, some of which are disclosed above. Examples of advanced epoxy resin hardeners may include, for example, epoxy resins prepared from bisphenol A diglycidyl ether (or the diglycidyl ether of tetrabromobisphenol A) and an excess of bisphenol or (tetrabromobisphenol). Anhydrides such as poly(styrene-co-maleic anhydride) may also be used.

Curing agents may also include primary and secondary polyamines and adducts thereof, anhydrides, and polyamides. For example, polyfunctional amines may include aliphatic amine compounds such as diethylene triamine (D.E.H. 20, available from The Dow Chemical Company, Midland, Mich.), triethylene tetramine (D.E.H. 24, available from The Dow Chemical Company, Midland, Mich.), tetraethylene pentamine (D.E.H.™ 26, available from The Dow Chemical Company, Midland, Mich.), as well as adducts of the above amines with epoxy resins, diluents, or other amine-reactive compounds. Aromatic amines, such as metaphenylene diamine and diamine diphenyl sulfone, aliphatic polyamines, such as amino ethyl piperazine and polyethylene polyamine, and aromatic polyamines, such as metaphenylene diamine, diamino diphenyl sulfone, and diethyltoluene diamine, may also be used.

Anhydride curing agents may include, for example, nadic methyl anhydride, hexahydrophthalic anhydride, trimellitic anhydride, dodecenyl succinic anhydride, phthalic anhydride, methyl hexahydrophthalic anhydride, tetrahydrophthalic anhydride, and methyl tetrahydrophthalic anhydride, among others.

The hardener or curing agent may include a phenol-derived or substituted phenol-derived novolac or an anhydride. Non-limiting examples of suitable hardeners include phenol novolac hardener, cresol novolac hardener, dicyclopentadiene bisphenol hardener, limonene type hardener, anhydrides, and mixtures thereof.

In some embodiments, the phenol novolac hardener may contain a biphenyl or naphthyl moiety. The phenolic hydroxy groups may be attached to the biphenyl or naphthyl moiety of the compound. This type of hardener may be prepared, for example, according to the methods described in EP915118A1. For example, a hardener containing a biphenyl moiety may be prepared by reacting phenol with bismethoxy-methylene biphenyl.

In other embodiments, curing agents may include dicyandiamide, boron trifluoride monoethylamine, and diaminocyclohexane. Curing agents may also include imidazoles, their salts, and adducts. These epoxy curing agents are typically solid at room temperature. Examples of suitable imadazole curing agents are disclosed in EP906927A1. Other curing agents include phenolic, benzoxazine, aromatic amines, amido amines, aliphatic amines, anhydrides, and phenols.

In some embodiments, the curing agents may be polyamides or an amino compound having a molecular weight up to 500 per amino group, such as an aromatic amine or a guanidine derivative. Examples of amino curing agents include 4-chlorophenyl-N,N-dimethyl-urea and 3,4-dichlorophenyl-N,N-dimethyl-urea.

Other examples of curing agents useful in embodiments disclosed herein include: 3,3′- and 4,4′-diaminodiphenylsulfone; methylenedianiline; bis(4-amino-3,5-dimethyl-phenyl)-1,4-diisopropylbenzene available as EPON 1062 from Hexion Chemical Co.; and bis(4-aminophenyl)-1,4-diisopropylbenzene available as EPON 1061 from Hexion Chemical Co.

Thiol curing agents for epoxy compounds may also be used, and are described, for example, in U.S. Pat. No. 5,374,668. As used herein, “thiol” also includes polythiol or polymercaptan curing agents. Illustrative thiols include aliphatic thiols such as methanedithiol, propanedithiol, cyclohexanedithiol, 2-mercaptoethyl-2,3-dimercapto-succinate, 2,3-dimercapto-1-propanol(2-mercaptoacetate), diethylene glycol bis(2-mercaptoacetate), 1,2-dimercaptopropyl methyl ether, bis(2-mercaptoethyl)ether, trimethylolpropane tris(thioglycolate), pentaerythritol tetra(mercaptopropionate), pentaerythritol tetra(thioglycolate), ethyleneglycol dithioglycolate, trimethylolpropane tris(beta-thiopropionate), tris-mercaptan derivative of tri-glycidyl ether of propoxylated alkane, and dipentaerythritol poly(beta-thiopropionate); halogen-substituted derivatives of the aliphatic thiols; aromatic thiols such as di-, tris- or tetra-mercaptobenzene, bis-, tris- or tetra-(mercaptoalkyl)benzene, dimercaptobiphenyl, toluenedithiol and naphthalenedithiol; halogen-substituted derivatives of the aromatic thiols; heterocyclic ring-containing thiols such as amino-4,6-dithiol-sym-triazine, alkoxy-4,6-dithiol-sym-triazine, aryloxy-4,6-dithiol-sym-triazine and 1,3,5-tris(3-mercaptopropyl) isocyanurate; halogen-substituted derivatives of the heterocyclic ring-containing thiols; thiol compounds having at least two mercapto groups and containing sulfur atoms in addition to the mercapto groups such as bis-, tris- or tetra(mercaptoalkylthio)benzene, bis-, tris- or tetra(mercaptoalkylthio)alkane, bis(mercaptoalkyl) disulfide, hydroxyalkylsulfidebis(mercaptopropionate), hydroxyalkylsulfidebis(mercaptoacetate), mercaptoethyl ether bis(mercaptopropionate), 1,4-dithian-2,5-diolbis(mercaptoacetate), thiodiglycolic acid bis(mercaptoalkyl ester), thiodipropionic acid bis(2-mercaptoalkyl ester), 4,4-thiobutyric acid bis(2-mercaptoalkyl ester), 3,4-thiophenedithiol, bismuththiol and 2,5-dimercapto-1,3,4-thiadiazol.

The curing agent may also be a nucleophilic substance such as an amine, a tertiary phosphine, a quaternary ammonium salt with a nucleophilic anion, a quaternary phosphonium salt with a nucleophilic anion, an imidazole, a tertiary arsenium salt with a nucleophilic anion, and a tertiary sulfonium salt with a nucleophilic anion.

Aliphatic polyamines that are modified by adduction with epoxy resins, acrylonitrile, or methacrylates may also be utilized as curing agents. In addition, various Mannich bases can be used. Aromatic amines wherein the amine groups are directly attached to the aromatic ring may also be used.

Quaternary ammonium salts with a nucleophilic anion useful as a curing agent in embodiments disclosed herein may include tetraethyl ammonium chloride, tetrapropyl ammonium acetate, hexyl trimethyl ammonium bromide, benzyl trimethyl ammonium cyanide, cetyl triethyl ammonium azide, N,N-dimethylpyrrolidinium isocyanate, N-methylpyrridinium phenolate, N-methyl-o-chloropyrridinium chloride, methyl viologen dichloride and the like.

The suitability of the curing agent for use herein may be determined by reference to manufacturer specifications or routine experimentation. Manufacturer specifications may be used to determine if the curing agent is an amorphous solid or a crystalline solid at the desired temperatures for mixing with the liquid or solid epoxy. Alternatively, the solid curing agent may be tested using differential scanning calorimetry (DSC) to determine the amorphous or crystalline nature of the solid curing agent and the suitability of the curing agent for mixing with the resin composition in either liquid or solid form.

Mixtures of one or more of the above described epoxy hardeners and curing agents may also be used.

Flame Retardant Additives

As described above, the curable compositions described herein may be used in formulations that contain halogenated and non-halogenated flame retardants, including brominated and non-brominated flame retardants. Specific examples of brominated additives include tetrabromobisphenol A (TBBA) and materials derived therefrom: TBBA-diglycidyl ether, reaction products of bisphenol A or TBBA with TBBA-diglycidyl ether, and reaction products of bisphenol A diglycidyl ether with TBBA.

Non-brominated flame retardants include the various materials derived from DOP (9,10-dihydro-9-oxa-10-phosphaphenanthrene 10-oxide) such as DOP-hydroquinone (10-(2′,5′-dihydroxyphenyl)-9,10-dihydro-9-oxa-10-phosphaphenanthrene 10-oxide), condensation products of DOP with glycidylether derivatives of novolacs, and inorganic flame retardants such as aluminum trihydrate, aluminum hydroxide (Boehmite) and aluminum phosphinite. If inorganic flame retardant fillers are used, silane treated grades are preferred.

Other flame retardant additives may include zinc salts of a carboxylic acid. Examples of the salt of a carboxylic acid with zinc include zinc formate, zinc acetate, zinc propionate, zinc butyrate, zinc valerate, zinc hexanoate, zinc octanoate, zinc dodecanoate, zinc laurate, zinc myristate, zinc palmitate, zinc stearate, zinc oxalate, zinc malonate, zinc succinate, zinc glutarate, zinc adipate, zinc pimelate, zinc suberate, zinc acetate, zinc sebacate, zinc acrylate, zinc methacrylate, zinc crotonate, zinc oleate, zinc fumarate, zinc maleate, zinc benzoate, zinc phthalate and zinc cinnamate. These zinc salts may be used alone or in combination as a mixture of two or more of them

Mixtures of one or more of the above described flame retardant additives may also be used.

Other Additives

Curable compositions disclosed herein may optionally include synergists, and conventional additives and fillers. Synergists may include, for example, magnesium hydroxide, zinc borate, and metallocenes), solvents (e.g., acetone, methyl ethyl ketone, and DOWANOL PMA). Additives and fillers may include, for example, silica, glass, talc, metal powders, titanium dioxide, wetting agents, pigments, coloring agents, mold release agents, coupling agents, ion scavengers, UV stabilizers, flexibilizing agents, and tackifying agents. Additives and fillers may also include fumed silica, aggregates such as glass beads, polytetrafluoroethylene, polyol resins, polyester resins, phenolic resins, graphite, molybdenum disulfide, abrasive pigments, viscosity reducing agents, boron nitride, mica, nucleating agents, and stabilizers, among others. Fillers may include functional or non-functional particulate fillers that may have a particle size ranging from 0.5 nm to 100 microns and may include, for example, alumina trihydrate, aluminum oxide, aluminum hydroxide oxide, metal oxides, and nano tubes). Fillers and modifiers may be preheated to drive off moisture prior to addition to the epoxy resin composition. Additionally, these optional additives may have an effect on the properties of the composition, before and/or after curing, and should be taken into account when formulating the composition and the desired reaction product. Silane treated fillers are preferred.

In other embodiments, compositions disclosed herein may include toughening agents. Toughening agents function by forming a secondary phase within the polymer matrix. This secondary phase is rubbery and hence is capable of crack growth arrestment, providing improved impact toughness. Toughening agents may include polysulfones, silicon-containing elastomeric polymers, polysiloxanes, and other rubber toughening agents known in the art.

In some embodiments, minor amounts of higher molecular weight, relatively non-volatile monoalcohols, polyols, and other epoxy- or isocyanato-reactive diluents may be used, if desired, to serve as plasticizers in the curable and thermoset compositions disclosed herein. For example, isocyanates, isocyanurates, cyanate esters, allyl containing molecules or other ethylenically unsaturated compounds, and acrylates may be used in some embodiments. Exemplary non-reactive thermoplastic resins include polyphenylsulfones, polysulfones, polyethersolufones, polyvinylidene fluoride, polyetherimide, polypthalimide, polybenzimidiazole, acyrlics, phenoxy, and urethane. In other embodiments, compositions disclosed herein may also include adhesion promoters such as modified organosilanes (epoxidized, methacryl, amino), acytlacetonates, and sulfur containing molecules.

In yet other embodiments, compositions disclosed herein may include wetting and dispersing aids, for example, modified organosilanes, BYK W 900 series and BYK W 9010, and modified fluorocarbons. In still other embodiments, compositions disclosed herein may include air release additives, for example, BYK A530, BYKA525, BYK A555, and BYK A 560. Embodiments disclosed herein may also include surface modifiers (e.g., slip and gloss additives) and mold release agents (e.g., waxes), and other functional additives or pre-reacted products to improve polymer properties.

Some embodiments may include other co-reactants that may be incorporated to obtain specific properties of the curable and electrical laminate compositions disclosed herein. Mixtures of co-reactants and/or one or more of the above described additives may also be used.

In other embodiments, thermosetting compositions disclosed herein may include fibrous reinforcement materials, such as continuous and/or chopped fibers. The fibrous reinforcement material may include glass fibers, carbon fibers, or organic fibers such as polyamide, polyimide, and polyester. The concentration of fibrous reinforcements used in embodiments of the thermosetting compositions may be between about 1 percent to about 95 percent by weight, based on the total weight of the composition; between about 5 percent and 90 percent by weight in other embodiments; between about 10 percent and 80 percent in other embodiments; between about 20 percent and 70 percent in other embodiments; and between 30 percent and 60 percent in yet other embodiments.

In other embodiments, compositions disclosed herein may include nanofillers. Nanofillers may include inorganic, organic, or metallic, and may be in the form of powders, whiskers, fibers, plates or films. The nanofillers may be generally any filler or combination of fillers having at least one dimension (length, width, or thickness) from about 0.1 to about 100 nanometers. For example, for powders, the at least one dimension may be characterized as the grain size; for whiskers and fibers, the at least one dimension is the diameter; and for plates and films, the at least one dimension is the thickness. Clays, for example, may be dispersed in an epoxy resin-based matrix, and the clays may be broken down into very thin constituent layers when dispersed in the epoxy resin under shear. Nanofillers may include clays, organo-clays, carbon nanotubes, nanowhiskers (such as SiC), SiO₂, elements, anions, or salts of one or more elements selected from the s, p, d, and f groups of the periodic table, metals, metal oxides, and ceramics.

The concentration of any of the above described additives, when used in the thermosetting compositions described herein, may be between about 1 percent and 95 percent, based on the total weight of the composition; between 2 percent and 90 percent in other embodiments; between 5 percent and 80 percent in other embodiments; between 10 percent and 60 percent in other embodiments, and between 15 percent and 50 percent in yet other embodiments.

Electrical Laminate Compositions/Varnish

The proportions of components may depend, in part, upon the properties desired in the electrical laminate composition or coating to be produced, the desired cure response of the composition, and the desired storage stability of the composition (desired shelf life).

For example, in some embodiments, curable compositions may be formed by admixing maleimides, epoxy resins, cyanate esters, and other components, where the relative amounts of the components may depend upon the desired properties of the electrical laminate composition.

In some embodiments, the maleimide blend may be present in an amount in the range from 0.1 to 99 weight percent, based on a total weight of the curable composition. In other embodiments, the maleimide blend may be present in the range from 5 to 90 weight percent, based on the combined weight of the maleimides, epoxy resins, and cyanate esters; from 10 to 60 weight percent in other embodiments; and from 15 to 50 weight percent in yet other embodiments. In other embodiments, the maleimide blend may be used in an amount in the range from 20 to 45 weight percent of the curable composition; from 25 to 45 weight percent in yet other embodiments; and from 30 to 40 weight percent in yet other embodiments.

In some embodiments, the epoxy resin may be present in an amount in the range from 0.1 to 99 weight percent, based on a total weight of the curable composition. In other embodiments, the epoxy resin may be present in the range from 5 to 90 weight percent, based on the combined weight of the maleimides, epoxy resin, and cyanate esters; from 10 to 80 weight percent in other embodiments; and from 10 to 50 weight percent in yet other embodiments. In other embodiments, the epoxy resin may be used in an amount in the range from 10 to 40 weight percent of the curable composition; and from 20 to 30 weight percent in yet other embodiments.

In some embodiments, the cyanate ester may be present in an amount range from 0.01 to 99 weight percent, based on a total weight of the curable composition. In other embodiments, the cyanate ester may be present in the range from 5 to 90 weight percent, based on the combined weight of the maleimides, epoxy resin, and cyanate esters; from 10 to 80 weight percent in other embodiments; and from 15 to 75 weight percent in yet other embodiments. In other embodiments, the cyanate ester may be used in an amount in the range from 20 to 70 weight percent of the curable composition; from 30 to 60 weight percent in yet other embodiments; and from 40 to 50 weight percent in yet other embodiments.

The proportions of other components may also depend, in part, upon the properties desired in the thermoset resins, electrical laminates, or coating to be produced. For example, variables to consider in selecting curing agents and amounts of curing agents may include the epoxy composition (if a blend), the desired properties of the electrical laminate composition (T_{g}, T_{d}, flexibility, electrical properties, etc.), desired cure rates, and the number of reactive groups per catalyst molecule, such as the number of active hydrogens in an amine. In some embodiments, the amount of curing agent used may vary from 0.1 to 150 parts per hundred parts epoxy resin, by weight. In other embodiments, the curing agent may be used in an amount ranging from 5 to 95 parts per hundred parts epoxy resin, by weight; and the curing agent may be used in an amount ranging from 10 to 90 parts per hundred parts epoxy resin, by weight, in yet other embodiments. In yet other embodiments, the amount of curing agent may depend on components other than the epoxy resin.

In some embodiments, thermoset resins formed from the above described curable compositions may have a glass transition temperature, as measured using differential scanning calorimetry, of at least 190° C. In other embodiments, thermoset resins formed from the above described curable compositions may have a glass transition temperature, as measured using differential scanning calorimetry, of at least 200° C.; at least 210° C. in other embodiments; at least 220° C. in other embodiments; and at least 230° C. in yet other embodiments.

In some embodiments, thermoset resins formed from the above described curable compositions may have a 5% decomposition temperature, T_{d}, as measured using thermogravimetric analyses (TGA), of at least 300° C. In other embodiments, thermoset resins formed from the above described curable compositions may have a T_{d} as measured using TGA, of at least 320° C.; at least 330° C. in other embodiments; at least 340° C. in other embodiments; and at least 350° C. in yet other embodiments.

The curable compositions described above may be disposed on a substrate and cured. In some embodiments, the curable compositions may be cured or reacted to form maleimide-triazine-epoxy compositions or bismaleimide-triazine-epoxy compositions.

In other embodiments, the curable compositions may be substantially free of particulates with improved homogeneity stability. For example, in some embodiments, the curable compositions may remain clear and homogeneous for at least 28 days in some embodiments, and at least 35 days in other embodiments, as measured by experimental analysis using a Gardner bubble viscosity tube, as detailed further below.

Substrates

The substrate or object is not subject to particular limitation. As such, substrates may include metals, such as stainless steel, iron, steel, copper, zinc, tin, aluminum, alumite and the like; alloys of such metals, and sheets which are plated with such metals and laminated sheets of such metals. Substrates may also include polymers, glass, and various fibers, such as, for example, carbon/graphite; boron; quartz; aluminum oxide; glass such as E glass, S glass, S-2 GLASS or C glass; and silicon carbide or silicon carbide fibers containing titanium. Commercially available fibers may include: organic fibers, such as KEVLAR; aluminum oxide-containing fibers, such as NEXTEL fibers from 3M; silicon carbide fibers, such as NICALON from Nippon Carbon; and silicon carbide fibers containing titanium, such as TYRRANO from Ube. In some embodiments, the substrate may be coated with a compatibilizer to improve the adhesion of the electrical laminate composition to the substrate.

Composites and Coated Structures

In some embodiments, composites may be formed by curing the curable compositions disclosed herein. In other embodiments, composites may be formed by applying a curable epoxy resin composition to a substrate or a reinforcing material, such as by impregnating or coating the substrate or reinforcing material to form a prepreg, and curing the prepreg under pressure to form the electrical laminate composition.

After the curable composition has been produced, as described above, it may be disposed on, in, or between the above described substrates, before, during, or after cure of an electrical laminate composition.

For example, a composite may be formed by coating a substrate with a curable composition. Coating may be performed by various procedures, including spray coating, curtain flow coating, coating with a roll coater or a gravure coater, brush coating, and dipping or immersion coating.

In various embodiments, the substrate may be monolayer or multi-layer. For example, the substrate may be a composite of two alloys, a multi-layered polymeric article, and a metal-coated polymer, among others, for example. In other various embodiments, one or more layers of the curable composition may be disposed on a substrate. Other multi-layer composites, formed by various combinations of substrate layers and electrical laminate composition layers are also envisaged herein.

In some embodiments, the heating of the curable composition may be localized, such as to avoid overheating of a temperature-sensitive substrate, for example. In other embodiments, the heating may include heating the substrate and the curable composition.

Curing of the curable compositions disclosed herein may require a temperature of at least about 30° C., up to about 250° C., for periods of minutes up to hours, depending on the epoxy resin, curing agent, and catalyst, if used. In other embodiments, curing may occur at a temperature of at least 100° C., for periods of minutes up to hours. Post-treatments may be used as well, such post-treatments ordinarily being at temperatures between about 100° C. and 250° C.

In some embodiments, curing may be staged to prevent exotherms. Staging, for example, includes curing for a period of time at a temperature followed by curing for a period of time at a higher temperature. Staged curing may include two or more curing stages, and may commence at temperatures below about 180° C. in some embodiments, and below about 150° C. in other embodiments.

In some embodiments, curing temperatures may range from a lower limit of 30° C., 40° C., 50° C., 60° C., 70° C., 80° C., 90° C., 100° C., 110° C., 120° C., 130° C., 140° C., 150° C., 160° C., 170° C., or 180° C. to an upper limit of 250° C., 240° C., 230° C., 220° C., 210° C., 200° C., 190° C., 180° C., 170° C., 160° C., where the range may be from any lower limit to any upper limit.

The curable compositions disclosed herein may be useful in composites containing high strength filaments or fibers such as carbon (graphite), glass, boron, and the like. Composites may contain from about 30% to about 70%, in some embodiments, and from 40% to 70% in other embodiments, of these fibers based on the total volume of the composite.

Fiber reinforced composites, for example, may be formed by hot melt prepregging. The prepregging method is characterized by impregnating bands or fabrics of continuous fiber with a thermosetting composition as described herein in molten form to yield a prepreg, which is laid up and cured to provide a composite of fiber and epoxy resin.

Other processing techniques can be used to form electrical laminate composites containing the curable compositions disclosed herein. For example, filament winding, solvent prepregging, and pultrusion are typical processing techniques in which the curable composition may be used. Moreover, fibers in the form of bundles may be coated with the curable composition, laid up as by filament winding, and cured to form a composite.

The curable compositions and composites described herein may be useful as adhesives, structural and electrical laminates, coatings, marine coatings, composites, powder coatings, adhesives, castings, structures for the aerospace industry, and as circuit boards and the like for the electronics industry.

In some embodiments, the curable compositions and resulting thermoset resins may be used in composites, coatings, adhesives, or sealants that may be disposed on, in, or between various substrates. In other embodiments, the curable compositions may be applied to a substrate to obtain an epoxy based prepreg. As used herein, the substrates include, for example, glass cloth, a glass fiber, glass paper, paper, and similar substrates of polyethylene and polypropylene. The obtained prepreg may be cut into a desired size. An electrical conductive layer may be formed on the laminate/prepreg with an electrical conductive material. As used herein, suitable electrical conductive materials include electrical conductive metals such as copper, gold, silver, platinum and aluminum. Such electrical laminates may be used, for example, as multi-layer printed circuit boards for electrical or electronics equipment. Laminates made from the maleimide-triazine-epoxy polymer blends are especially useful for the production of HDI (high density interconnect) boards. Examples of HDI boards include those used in cell phones or those used for Interconnect (IC) substrates.

### EXAMPLES

### Test Methods

Glass transition temperature, T_{g}, is determined by differential scanning calorimetry (DSC) (IPC Method IPC-TM-650 2.4.25).

Degradation temperature, T_{d}, at 5% weight loss is measured according to IPC Method IPC-TM-650 2.4.24.6, using a thermo-gravimetric analyzer (TGA) ramped to 800° C. at 5° C. per minute under a nitrogen atmosphere. The T_{d} measurement is the temperature at which 5 weight percent of the sample is lost to decomposition products.

Stability data for the curable compositions are measured using Gardner bubble viscometers. Stability data includes viscosity and appearance; each may be measured by sealing a sample of the curable composition in a Gardner bubble tube. Stability data is measured according to AOC Method Ka 6-63, ASTM D 1131, D 1545, D 1725, and FTMS141a Method 4272. Viscosity data is measured using the time it takes for an air bubble to rise through the sample in the Gardner bubble tube. Viscosity is classified on a scale of <A, A, B, C, and D, with <A being less viscous than D.

The sample preparation procedure begins by preheating a flask, which is fitted with a condenser, thermocouple, stirring rod, and nitrogen inlet. Components may be added at temperature and stirred upon melting. The temperature may be maintained or increased and additional components may be added. The sample is allowed to cool to room temperature and is placed in an appropriate sample holder. Measurements may then be taken on the sample.

Laminate blanks may be prepared as follows. A laminate blank, also called prepreg (“pre-impregnated” composited fiber), is made using a LITZLER treater with zone temperatures set at 170° C. The prepreg powder stroke gel time is adjusted to 80+/−15 seconds. Laminates are pressed using a TETRAHEDRON press under vacuum at 220° C. with a hold time of 90 minutes. The laminate data is collected according to IPC (IPC, Association Connecting Electronics Industries, formerly Institute for Interconnecting and Packaging Electronic Circuits) standard methods. Data collected on the laminate blanks include T_{g} and T_{d}. Additional data collected include α₁ and α₂, time to delamination, average copper peel strength, average moisture uptake, stability during solder dip, total burn time, and flame retardancy.

Copper peel strength is measured using the method described in IPC Method IPC-TM-650-2.4.8C.

The α₁ and α₂ CTE values are collected via thermomechanical analysis (TMA) using an 8 layer, copper clad laminate with dimensions of approximately 5 mm by 5 mm by 1.5 mm thick. The sample is heated with the probe on the surface of the sample at 10° C./minute to 288° C. using a TA Instruments Q400 TMA. The expansion of the sample is measured and the CTE values are calculated below the T_{g} (α₁) and above the T_{g} (α₂).

Time to delamination is measured using a thermal mechanical analyzer (TMA) at constant temperature. The sample delaminates when the internal pressure from gaseous decomposition products is high enough to crack the matrix or cause adhesive/cohesive failure and the subsequent change in dimension is used to determine the end point. The time to delamination was measured according to IPC-TM-650-2.2.24.1.

Average moisture uptake is measured using a two hour autoclave exposure at a temperature of 121° C. at 15 psi. Flame retardancy is measured using the UL-94 rating method.

Stability during solder dip is measured by exposing the sample to a 288° C. solder dip and observing the sample for blistering, employing IPC test method TM-650.

### Example 1

A preheated (120° C.) 250 ml 3 neck flask, fitted with a condenser, thermocouple, stirring rod, and nitrogen inlet, is charged with 35.42 g of D.E.R.™ 560 and 51.28 g of D.E.R.™ 592 (each of which are brominated epoxy resins available from The Dow Chemical Company, Midland, Mich.). The nitrogen flow is set at 60 cc per minute. After 15 minutes at temperature, the solid epoxy resins melts and the stir motor is set at 90 rpm. 18.88 g of COMPIMIDE MDAB (4,4′-bismaleimido-diphenylmethane, available from Degussa, GMBH) and 6.27 g of N-phenylmaleimide (available from Hos-Tec, GMBH) are added to the flask. The temperature setting is raised to 130° C. After 45 minutes at 130° C., the heating source is turned off and 64.29 g of methyl ethyl ketone is added to the flask dropwise via an addition funnel. In a 20 ml vial, 11.61 g of the mixture is blended with 3.37 g of PRIMASET BA-230s (0.01 mol cyanate ester, available from Lonza Corporation), and 0.04 g of a 5% solution of Zn Hexanoate in methyl ethyl ketone. The resultant mixture is dark amber and clear.

### Example 2

A preheated (120° C.) 250 ml 3 neck flask fitted with a condenser, thermocouple, stirring rod, and nitrogen inlet is charged with 35.45 g of D.E.R.™ 560 and 51.43 g of D.E.R.™ 592. The nitrogen flow is set at 60 cc per minute. After 15 minutes at temperature, the solid epoxy resins melts and the stir motor is set at 90 rpm. 12.44 g of COMPIMIDE MDAB and 12.42 g of N-phenylmaleimide are added to the flask. The temperature setting is raised to 130° C. After 45 minutes at 130° C., the heating source is turned off and 64.29 g of methyl ethyl ketone is added to the flask dropwise via an addition funnel. In a 20 ml vial, 11.59 g of the mixture is blended with 3.4 g of PRIMASET BA-230s (0.01 mol cyanate ester), and 0.04 g of a 5% solution of Zn Hexanoate in methyl ethyl ketone. The resultant mixture is light amber and clear.

### Example 3

A preheated (120° C.) 250 ml 3 neck flask fitted with a condenser, thermocouple, stirring rod, and nitrogen inlet is charged with 35.58 g of D.E.R.™ 560 and 51.74 g of D.E.R.™ 592. The nitrogen flow is set at 60 cc per minute. After 15 minutes at temperature, the solid epoxy resins melts and the stir motor is set at 90 rpm. 6.19 g of COMPIMIDE MDAB and 18.51 g of N-phenylmaleimide are added to the flask. The temperature setting is raised to 130° C. After 45 minutes at 130° C., the heating source is turned off and 64.29 g of methyl ethyl ketone is added to the flask dropwise via an addition funnel. In a 20 ml vial, 11.66 g of the mixture is blended with 3.35 g of PRIMASET BA-230s (0.01 mol cyanate ester), and 0.04 g of a 5% solution of Zn Hexanoate in methyl ethyl ketone. The resultant mixture is light amber and clear.

### Example 4

A preheated (120° C.) 250 ml 3 neck flask fitted with a condenser, thermocouple, stirring rod, and nitrogen inlet is charged with 35.45 g of D.E.R.™ 560 and 51.43 g of D.E.R.™ 592. The nitrogen flow is set at 60 cc per minute. After 15 minutes at temperature, the solid epoxy resins melts and the stir motor is set at 90 rpm. 12.44 g of COMPIMIDE MDAB and 12.42 g of N-phenylmaleimide are added to the flask. The temperature setting is raised to 130° C. After 45 minutes at 130° C., the heating source is turned off and 64.29 g of methyl ethyl ketone is added to the flask dropwise via an addition funnel. In a 20 ml vial, 11.98 g of the mixture is blended with 4.08 g of PRIMASET BA-230s (0.012 mol cyanate ester), and 0.03 g of a 5% solution of Zn Hexanoate in methyl ethyl ketone. The 20 ml vial is placed on a shaker on low speed for 30 minutes. The resultant mixture is light amber and clear.

### Example 5

A preheated (120° C.) 250 ml 3 neck flask fitted with a condenser, thermocouple, stirring rod, and nitrogen inlet is charged with 35.45 g of D.E.R.™ 560 and 51.43 g of D.E.R.™ 592. The nitrogen flow is set at 60 cc per minute. After 15 minutes at temperature, the solid epoxy resins melts and the stir motor is set at 90 rpm. 12.44 g of COMPIMIDE MDAB and 12.42 g of N-phenylmaleimide are added to the flask. The temperature setting is raised to 130° C. After 45 minutes at 130° C., the heating source is turned off and 64.29 g of methyl ethyl ketone is added to the flask dropwise via an addition funnel. In a 20 ml vial, 10.02 g of the mixture is blended with 6.06 g of PRIMASET BA-230s (0.018 mol cyanate ester), and 0.03 g of a 5% solution of Zn Hexanoate in methyl ethyl ketone. The 20 ml vial is placed on a shaker on low speed for 30 minutes. The resultant mixture is light amber and clear.

### Example 6

A preheated (120° C.) 250 ml 3 neck flask fitted with a condenser, thermocouple, stirring rod, and nitrogen inlet is charged with 35.45 g of D.E.R.™ 560 and 51.43 g of D.E.R.™ 592. The nitrogen flow is set at 60 cc per minute. After 15 minutes at temperature, the solid epoxy resins melts and the stir motor is set at 90 rpm. 12.44 g of COMPIMIDE MDAB and 12.42 g of N-phenylmaleimide are added to the flask. The temperature setting is raised to 130° C. After 45 minutes at 130° C., the heating source is turned off and 64.29 g of methyl ethyl ketone is added to the flask dropwise via an addition funnel. In a 20 ml vial, 7.99 g of the mixture is blended with 8.11 g of PRIMASET BA-230s (0.024 mol cyanate ester), and 0.03 g of a 5% solution of Zn Hexanoate in methyl ethyl ketone. The 20 ml vial is placed on a shaker on low speed for 30 minutes. The resultant mixture is light amber and clear.

### Example 7

A preheated (120° C.) 250 ml 3 neck flask fitted with a condenser, thermocouple, stirring rod, and nitrogen inlet is charged with 35.45 g of D.E.R.™ 560 and 51.43 g of D.E.R.™ 592. The nitrogen flow is set at 60 cc per minute. After 15 minutes at temperature, the solid epoxy resins melts and the stir motor is set at 90 rpm. 12.44 g of COMPIMIDE MDAB and 12.42 g of N-phenylmaleimide are added to the flask. The temperature setting is raised to 130° C. After 45 minutes at 130° C., the heating source is turned off and 64.29 g of methyl ethyl ketone is added to the flask dropwise via an addition funnel. In a 20 ml vial, 6.11 g of the mixture is blended with 10.12 g of PRIMASET BA-230s (0.03 mol cyanate ester), and 0.03 g of a 5% solution of Zn Hexanoate in methyl ethyl ketone. The 20 ml vial is placed on a shaker on low speed for 30 minutes. The resultant mixture is light amber and clear.

### Example 8

A preheated (120° C.) 250 ml 3 neck flask, fitted with a condenser, thermocouple, stirring rod, and nitrogen inlet, is charged with 35.42 g of D.E.R.™ 560 (brominated epoxy resin) and 51.28 g of D.E.R.™ 592. The nitrogen flow is set at 60 cc per minute. After 15 minutes at temperature, the solid epoxy resins melts and the stir motor is set at 90 rpm. 18.88 g of COMPIMIDE MDAB (4,4′-bismaleimido-diphenylmethane) and 6.27 g of N-phenylmaleimide are added to the flask. The temperature setting is raised to 130° C. After 45 minutes at 130° C., the heating source is turned off and 64.29 g of methyl ethyl ketone is added to the flask dropwise via an addition funnel. In a 20 ml vial, 6.02 g of the mixture is blended with 10.04 g of PRIMASET BA-230s (0.03 mol cyanate ester), and 0.03 g of a 5% solution of Zn Hexanoate in methyl ethyl ketone. The 20 ml vial is placed on a shaker on low speed for 30 minutes. The resultant mixture is dark amber and clear.

### Example 9

A preheated (120° C.) 250 ml 3 neck flask, fitted with a condenser, thermocouple, stirring rod, and nitrogen inlet, is charged with 35.42 g of D.E.R.™ 560 (brominated epoxy resin) and 51.28 g of D.E.R.™ 592. The nitrogen flow is set at 60 cc per minute. After 15 minutes at temperature, the solid epoxy resins melts and the stir motor is set at 90 rpm. 18.88 g of COMPIMIDE MDAB (4,4′-bismaleimido-diphenylmethane) and 6.27 g of N-phenylmaleimide are added to the flask. The temperature setting is raised to 130° C. After 45 minutes at 130° C., the heating source is turned off and 64.29 g of methyl ethyl ketone is added to the flask dropwise via an addition funnel. In a 20 ml vial, 10.09 g of the mixture is blended with 5.99 g of PRIMASET BA-230s (0.018 mol cyanate ester), and 0.03 g of a 5% solution of Zn Hexanoate in methyl ethyl ketone. The 20 ml vial is placed on a shaker on low speed for 30 minutes. The resultant mixture is dark amber and clear.

### Example 10

A preheated (120° C.) 250 ml 3 neck flask fitted with a condenser, thermocouple, stirring rod, and nitrogen inlet is charged with 35.58 g of D.E.R.™ 560 and 51.74 g of D.E.R.™ 592. The nitrogen flow is set at 60 cc per minute. After 15 minutes at temperature, the solid epoxy resins melts and the stir motor is set at 90 rpm. 6.19 g of COMPIMIDE MDAB and 18.51 g of N-phenylmaleimide are added to the flask. The temperature setting is raised to 130° C. After 45 minutes at 130° C., the heating source is turned off and 64.29 g of methyl ethyl ketone is added to the flask dropwise via an addition funnel. In a 20 ml vial, 6.01 g of the mixture is blended with 10.01 g of PRIMASET BA-230s (0.03 mol cyanate ester), and 0.03 g of a 5% solution of Zn Hexanoate in methyl ethyl ketone. The 20 ml vial is placed on a shaker on low speed for 30 minutes. The resultant mixture is light amber and clear.

### Example 11

A preheated (120° C.) 250 ml 3 neck flask fitted with a condenser, thermocouple, stirring rod, and nitrogen inlet is charged with 35.58 g of D.E.R.™ 560 and 51.74 g of D.E.R.™ 592. The nitrogen flow is set at 60 cc per minute. After 15 minutes at temperature, the solid epoxy resins melts and the stir motor is set at 90 rpm. 6.19 g of COMPIMIDE MDAB and 18.51 g of N-phenylmaleimide are added to the flask. The temperature setting is raised to 130° C. After 45 minutes at 130° C., the heating source is turned off and 64.29 g of methyl ethyl ketone is added to the flask dropwise via an addition funnel. In a 20 ml vial, 10.00 g of the mixture is blended with 6.03 g of PRIMASET BA-230s (0.018 mol cyanate ester), and 0.03 g of a 5% solution of Zn Hexanoate in methyl ethyl ketone. The 20 ml vial is placed on a shaker on low speed for 30 minutes. The resultant mixture is light amber and clear.

### Comparative Example 1

23.58 g (0.0519 mol epoxy) of D.E.R.™ 560, 34.38 g (0.0955 mol epoxy) of D.E.R.™ 592, 16.89 g (0.0938 mol maleimide) of COMPIMIDE MDAB and 42.85 g of methyl ethyl ketone are added to an 8 oz narrow mouth glass jar. The jar is placed on a roller overnight on medium speed at approximately 300 rpm. The resultant mixture exhibits a light yellow turbid appearance. In a 20 ml vial, 11.65 g of the mixture is blended with 3.35 g of PRIMASET BA-230s (0.01 mol cyanate ester), and 0.02 g of a 5% solution of Zn Hexanoate in methyl ethyl ketone. The blended system is placed on a shaker for 30 minutes.

### Comparative Example 2

23.73 g of D.E.R.™ 560, 34.11 g of D.E.R.™ 592, 16.34 g of N-phenylmaleimide, and 42.88 g of methyl ethyl ketone are added to an 8 oz narrow mouth glass jar. The jar is placed on a roller for 1.5 hours on medium speed at approximately 300 rpm. The resultant mixture exhibits a light yellow clear appearance. In a 20 ml vial, 11.65 g of the mixture is blended with 3.38 g of PRIMASET BA-230s (0.01 mol cyanate ester), and 0.02 g of a 5% solution of Zn Hexanoate in methyl ethyl ketone. The blended system is placed on a shaker for 30 minutes

### Comparative Example 3

28.32 g of D.E.R.™ 560, 41.22 g of D.E.R.™ 592, and 42.88 g of methyl ethyl ketone are added to an 8 oz narrow mouth glass jar. The jar is placed on a roller for 1.5 hours on medium speed at approximately 300 rpm. The resultant mixture exhibits a light yellow clear appearance. In a 20 ml vial, 11.00 g of the mixture is blended with 4.0 g of PRIMASET BA-230s (0.011 mol cyanate ester), and 0.02 g of a 5% solution of Zn Hexanoate in methyl ethyl ketone. The blended system is placed on a shaker for 30 minutes.

### Comparative Example 4

23.61 g of D.E.R.™ 560, 34.27 g of D.E.R.™ 592. 12.58 g of COMPIMIDE MDAB, 4.19 g of N-phenylmaleimide, and 42.87 g of methyl ethyl ketone are added to an 8 oz narrow mouth glass jar. The jar is placed on a roller for 5 hours on medium speed at approximately 300 rpm. The resultant mixture exhibits a light yellow turbid appearance. In a 20 ml vial, 11.66 g of the mixture is blended with 3.33 g of PRIMASET BA-230s (0.01 mol cyanate ester), and 0.03 g of a 5% solution of Zn Hexanoate in methyl ethyl ketone. The blended system is placed on a roller for 60 minutes.

### Comparative Example 5

23.83 g of D.E.R.™ 560, 34.81 g of D.E.R.™ 592, 4.11 g of COMPIMIDE MDAB, 12.34 g of N-phenylmaleimide, and 42.86 g of methyl ethyl ketone are added to an 8 oz narrow mouth glass jar. The jar is placed on a roller for 5 hours on medium speed at approximately 300 rpm. The resultant mixture exhibits a light yellow turbid appearance. In a 20 ml vial, 11.95 g of the mixture is blended with 3.35 g of PRIMASET BA-230s (0.01 mol cyanate ester), and 0.03 g of a 5% solution of Zn Hexanoate in methyl ethyl ketone. The blended system is placed on a roller for 60 minutes.

### Comparative Example 6

23.78 g of D.E.R.™ 560, 34.25 g of D.E.R.™ 592, 8.29 g of COMPIMIDE MDAB, 8.31 g of N-phenylmaleimide, and 42.86 g of methyl ethyl ketone are added to an 8 oz narrow mouth glass jar. The jar is placed on a roller for 5 hours on medium speed at approximately 300 rpm. The resultant mixture exhibits a light yellow turbid appearance. In a 20 ml vial, 11.66 g of the mixture is blended with 3.38 g of PRIMASET BA-230s (0.01 mot cyanate ester), and 0.03 g of a 5% solution of Zn Hexanoate in methyl ethyl ketone. The blended system is placed on a roller for 60 minutes.

The results of the Examples and Comparative Examples are shown in Table 1.

TABLE 1

| | | | 5% |
|---|---|---|---|
| | | Glass Transition | Decomposition |
| | Formulation | Temperature | Temperature |
| | Appearance | (° C.) | (° C.) |
| Comparative | Yellow, Turbid, | 223.1 | 320.4 |
| Example 1 | Inhomogeneous | | |
| Comparative | Yellow - Clear | 199.9 | 312.8 |
| Example 2 | | | |
| Comparative | Clear | 193.1 | 312.0 |
| Example 3 | | | |
| Comparative | Yellow, Turbid, | 215.6 | 320.9 |
| Example 4 | Inhomogeneous | | |
| Comparative | Yellow, Turbid, | 211.9 | 319.5 |
| Example 5 | Inhomogeneous | | |
| Comparative | Yellow, Turbid, | 205.7 | 317.2 |
| Example 6 | Inhomogeneous | | |
| Example 1 | Dark Amber, Clear, | 217.4 | 318.8 |
| | Homogeneous | | |
| Example 2 | Dark Amber, Clear, | 213.2 | 319.9 |
| | Homogeneous | | |
| Example 3 | Dark Amber, Clear, | 203.6 | 318.4 |
| | Homogeneous | | |
| Example 4 | Dark Amber, Clear, | 217.0 | 320.3 |
| | Homogeneous | | |
| Example 5 | Dark Amber, Clear, | 226.4 | 320.6 |
| | Homogeneous | | |
| Example 6 | Dark Amber, Clear, | 237.6 | 321.8 |
| | Homogeneous | | |
| Example 7 | Dark Amber, Clear, | 252.0 | 325.1 |
| | Homogeneous | | |
| Example 8 | Dark Amber, Clear, | 255.8 | 326.0 |
| | Homogeneous | | |
| Example 9 | Dark Amber, Clear, | 232.1 | 320.4 |
| | Homogeneous | | |
| Example 10 | Dark Amber, Clear, | 250.6 | 326.2 |
| | Homogeneous | | |
| Example 11 | Dark Amber, Clear, | 222.0 | 318.8 |
| | Homogeneous | | |

Comparative Example 1 is a baseline formulation with 4,4′-bismaleimido-diphenylmethane (MDAB) admixed at room temperature. The resultant formulation, after addition of the cyanate ester component, is a yellow, turbid mixture, due to the MDAB being incorporated in suspension. The baseline T_{g} target is 223° C. and the baseline T_{d} target is 320° C.

In Comparative Example 2, the MDAB is replaced with phenylmaleimide and blended at room temperature. The resultant formulation, after addition of the cyanate ester, is clear and homogeneous, however the T_{g} at 199° C. is approximately 24° C. lower than the baseline T_{g}. In addition, the T_{d} is lower than the baseline T_{d}.

Comparative Example 3 contains no maleimide component and is blended at room temperature. The resultant formulation, after addition of the cyanate ester is clear, however the T_{g} is 193° C., 30° C. lower than the baseline T_{g}. The T_{d} is lower than the baseline T_{d} as well.

Comparative Example 4 contains a 3:1 blend of MDAB:PMI, blended at room temperature. The resultant formulation, after addition of the cyanate ester, is a yellow, turbid solution. The T_{g} at 215° C. is slightly lower than the baseline T_{g}, however the T_{d} is equivalent to the baseline T_{d}.

Comparative Example 5 contains a 1:1 blend of MDAB:PMI. The resultant formulation, after addition of the cyanate ester, is a yellow turbid solution. The T_{g} at 212° C. is approximately 11° C. lower than the baseline T_{g}, however the T_{d} is at 320° C.

Comparative Example 6 contains a 1:3 blend of MDAB:PMI. The T_{g} is 206° C., 17° C. lower than the baseline T_{g}. In addition, the T_{d} is 317° C.

Example 1 contains the same ingredient ratios as Comparative Example 4, however the maleimide components are incorporated at an elevated temperature of 130° C. The resultant formulation, after addition of the cyanate ester, is a clear, dark amber solution free of particulates. The T_{g} at 217° C. is slightly lower than the baseline of 223° C. The T_{d} is 319° C.

Example 2 contains the same ingredient ratios as Comparative Example 5, however the maleimide components are incorporated at an elevated temperature of 130° C. The resultant formulation, after addition of the cyanate ester, is a clear, dark amber solution free of particulates. The T_{g}, at 213° C., is 10° C. This is lower than the baseline of 223° C. The T_{d} is 320° C.

Example 3 contains the same ingredient ratios as Comparative Example 6, however the maleimide components are incorporated at an elevated temperature of 130° C. The resultant formulation, after addition of the cyanate ester, is a clear, dark amber solution free of particulates. The T_{g}, at 204° C., is 19° C. This is lower than the baseline of 223° C. The T_{d} is 318° C.

Examples 4 through 11 utilize the incorporation procedure outlined in Example 1 and as described above. Example 4 contains the same molar ratios of the maleimide and epoxy components contained in Example 1. The cyanate ester molar ratio is adjusted to determine the effect on T_{g} and T_{d}. The resultant formulation, after addition of the cyanate ester component, is a clear, dark amber solution, free of particulates. The T_{g}, at 217° C., is lower than the baseline of 223° C. In addition, the T_{d} is 320° C.

Example 5 contains the same molar ratios of the maleimide and epoxy components contained in Example 1. The cyanate ester molar ratio is adjusted to determine the effect on T_{g} and T_{d}. The resultant formulation, after addition of the cyanate ester component, is a clear, dark amber solution, free of particulates. The T_{g}, at 226° C., is higher than the baseline at 223° C. In addition, the T_{d} is 321° C.

Example 6 contains the same molar ratios of the maleimide and epoxy components contained in Example 1. The cyanate ester molar ratio is adjusted to determine the effect on T_{g} and T_{d}. The resultant formulation, after addition of the cyanate ester component, is a clear, dark amber solution, free of particulates. The T_{g}, at 238° C., is higher than the baseline at 223° C. In addition, the T_{d} is 322° C.

Example 7 contains the same molar ratios of the maleimide and epoxy components contained in Example 1. The cyanate ester molar ratio is adjusted to determine the effect on T_{g} and T_{d}. The resultant formulation, after addition of the cyanate ester component, is a clear, dark amber solution, free of particulates. The T_{g}, at 252° C., is higher than the target at 223° C. In addition, the T_{d} is 325° C.

Example 8 contains the same molar ratios of the maleimide and epoxy components contained in Example 2. The cyanate ester molar ratio is adjusted to determine the effect on T_{g} and T_{d}. The resultant formulation, after addition of the cyanate ester component, is a clear, dark amber solution, free of particulates. The T_{g}, at 256° C., is higher than the baseline at 223° C. In addition, the T_{d} is 326° C.

Example 9 contains the same molar ratios of the maleimide and epoxy components contained in Example 2. The cyanate ester molar ratio is adjusted to determine the effect on T_{g} and T_{d}. The resultant formulation, after addition of the cyanate ester component, is a clear, dark amber solution, free of particulates. The T_{g}, at 232° C., is higher than the baseline at 223° C. In addition, the T_{d} is 320° C.

Example 10 contains the same molar ratios of the maleimide and epoxy components contained in Example 3. The cyanate ester molar ratio is adjusted to determine the effect on T_{g} and T_{d}. The resultant formulation, after addition of the cyanate ester component, is a clear, dark amber solution, free of particulates. The T_{g}, at 251° C., is higher than the baseline at 223° C. In addition, the T_{d} is 326° C.

Example 11 contains the same molar ratios of the maleimide and epoxy components contained in Example 3. The cyanate ester molar ratio is adjusted to determine the effect on T_{g} and T_{d}. The resultant formulation, after addition of the cyanate ester component, is a clear, dark amber solution, free of particulates. The T_{g} is 222° C. In addition, the T_{d} is 319° C.

Viscosity and appearance stability data are collected on select Examples and are presented in Table 2.

TABLE 2

| Example | Property | Day 0 | Day 7 | Day 14 | Day 22 | Day 35 | Day 49 |
|---|---|---|---|---|---|---|---|
| 5 | Viscosity | <A | <A | A | A | A | NA |
| | Appearance | Clear | Clear | Clear | Turbid | Turbid | NA |
| | Stability Data | | | | | | |
| 6 | Viscosity | A | A | A/B | B | B | NA |
| | Appearance | Clear | Clear | Clear | Turbid | Turbid | NA |
| | Stability Data | | | | | | |
| 7 | Viscosity | C | C | D | D | D | NA |
| | Appearance | Clear | Clear | Clear | Turbid | Turbid | NA |
| | Stability Data | | | | | | |
| 8 | Viscosity | C | C | C/D | D | D | NA |
| | Appearance | Clear | Clear | Clear | Turbid | Turbid | NA |
| | Stability Data | | | | | | |
| 9 | Viscosity | <A | <A | <A | A | A | NA |
| | Appearance | Clear | Clear | Clear | Clear | Turbid | NA |
| | Stability Data | | | | | | |
| 10 | Viscosity | <A | <A | <A | <A | <A | C |
| | Appearance | Clear | Clear | Clear | Clear | Clear | Turbid |
| | Stability Data | | | | | | |
| 11 | Viscosity | B | C | C | C | C | C |
| | Appearance | Clear | Clear | Clear | Clear | Clear | Turbid |
| | Stability Data | | | | | | |

Samples of each formulation with no catalyst are added to a Gardner bubble viscosity tube and viscosity and appearance data are collected. The data in Table 2 indicate the variability in appearance and viscosity stability of the samples. The appearance stability ranges from 22 to 49 days.

An exemplary embodiment is produced at an MDAB:PMI weight ratio of 60:40 and a maleimide and epoxy to cyanate ester weight ratio of 2:1 according to the following formulation.

TABLE 3

| Ingredient | Formula Weight |
|---|---|
| D.E.R. ™ 560 | 0.2116 |
| D.E.R. ™ 592 | 0.3060 |
| 4,4′-bismaleimido-diphenylmethane | 0.0894 |
| Phenylmaleimide | 0.0596 |
| PRIMASET BA-230s | 0.3333 |
| Total | 1.0000 |

The ingredients are in methyl ethyl ketone at 72% by weight solids. The exemplary embodiment exhibits a T_{g} of 226° C. and a T_{d} of 321° C., while maintaining homogeneity for greater than 4 weeks at room temperature.

Laminate samples are prepared using a formulation of the exemplary embodiment and a formulation of Comparative Example 1. Data are presented below in Table 3:

TABLE 4

| | MDAB in | (No | | |
|---|---|---|---|---|
| | Suspension | Maleimide) | (MDAB:PMI) | Desirability |
| T_{g3} (° C.) | 222 | 214 | 231 | Higher |
| [DSC, | | | | |
| 20° C./min] | | | | |
| T_{d} (° C.) | 323 | 317 | 324 | Higher |
| [5% wt. loss | | | | |
| via TGA] | | | | |
| T_{g} (° C.) | 204 | 199 | 223 | Higher |
| [TMA, | | | | |
| 20° C./min] | | | | |
| α₁ (ppm/ | 50 | 38 | 43 | Lower |
| ° C.) [CTE, | | | | |
| TMA] | | | | |
| α₂ (ppm/ | 313 | 272 | 253 | Lower |
| ° C.) [CTE, | | | | |
| TMA] | | | | |
| Time to | 6.6 | 4.9 | 9.5 | Higher |
| Delami- | | | | |
| nation | | | | |
| (min) | | | | |
| Average | 7.488 | 8.0 | 7.6 | Higher |
| Copper | | | | |
| Peel Strength | | | | |
| (lb/in) | | | | |
| Average | 0.3153 | 0.2352 | 0.2680 | Lower |
| Moisture | | | | |
| Uptake (2 h | | | | |
| autoclave | | | | |
| exposure, %) | | | | |
| 288° C. | 100 | 100 | 100 | 100% |
| solder dip | | | | |
| (% pass) | | | | |
| Total burn | 11 | 11 | 13 | Lower |
| time (s) | | | | |
| UL-94 rating | V-0 | V-0 | V-0 | V-0 |

The data indicate that MDAB:PMI blends resulted in improved performance over the MDAB in suspension and the sample containing no maleimide.

As described above, curable compositions disclosed herein include maleimide components, epoxy resin components, cyanate ester components, and optional components such as catalysts, hardeners, or curing agents. Advantageously, embodiments disclosed herein may provide for compositions having improved clarity with less particulate matter. Other advantages may include having improved homogeneity and/or improved stability of homogeneity. Further advantages may include one or more of improved ease-of-use and maintenance or improvement of key performance attributes, such as glass transition temperature and decomposition temperatures.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

1. A process for forming a curable composition, comprising:
admixing an epoxy resin and a maleimide component comprising at least one bismaleimide at a temperature in the range from about 50° C. to about 250° C.;
admixing a cyanate ester component with the epoxy-maleimide admixture to form a homogeneous solution.

2. The process of claim 1, wherein the maleimide component comprises a phenyl maleimide and a 4,4′-bismaleimido-diphenylmethane.

3. The process of claim 2, wherein a weight ratio of the phenyl maleimide to the 4,4-bismaleimido-diphenylmethane is in the range from 95:5 to 5:95.

4. The process of claim 2, wherein a weight ratio of the phenyl maleimide to the 4,4′-bismaleimido-diphenylmethane is in the range from 25:75 to 75:25.

5. The process of claim 2, wherein a weight ratio of the phenyl maleimide to the 4,4′-bismaleimido-diphenylmethane is in the range from 65:35 to 35:65.

6. The process of claim 1, wherein the cyanate ester component comprises at least one of a cyanate ester and a partially trimerized cyanate ester.

7. The process of claim 1, wherein a molar ratio of the maleimide component to the epoxy resin to the cyanate ester component in the homogeneous solution is in the range from 90:5:5 to 5:90:5 to 5:5:90, wherein the molar ratio is based on the functional groups of the respective components.

8. The process of claim 1, wherein a molar ratio of the maleimide component to the epoxy resin to the cyanate ester component in the homogeneous solution is in the range from 30:20:50 to 50:30:20 to 20:50:30, wherein the molar ratio is based on the functional groups of the respective components.

9. A curable composition, comprising:
a maleimide component comprising at least one bismaleimide;
a cyanate ester component; and
an epoxy resin;
wherein the curable composition is a homogeneous solution.

10. The curable composition of claim 9, wherein the maleimide component comprises a phenyl maleimide and a 4,4′-bismaleimido-diphenylmethane.

11. The curable composition of claim 10, wherein a weight ratio of the phenyl maleimide to the 4,4′-bismaleimido-diphenylmethane is in the range from 95:5 to 5:95.

12. The composition of claim 10, wherein a weight ratio of the phenyl maleimide to the 4,4′-bismaleimido-diphenylmethane is in the range from 25:75 to 75:25.

13. The composition of claim 9, wherein the cyanate ester component comprises at least one of a cyanate ester and a partially trimerized cyanate ester.

14. The composition of claim 9, wherein a molar ratio of the maleimide component to the epoxy resin to the cyanate ester component in the homogeneous solution is in the range from 90:5:5 to 5:90:5 to 5:5:90, wherein the molar ratio is based on the functional groups of the respective components.

15. The composition of claim 9, wherein a molar ratio of the maleimide component to the epoxy resin to the cyanate ester component in the homogeneous solution is in the range from 30:20:50 to 50:30:20 to 20:50:30, wherein the molar ratio is based on the functional groups of the respective components.

16. The curable composition of claim 9, wherein the composition remains as a homogeneous solution for at least twenty-eight days, where solution stability is measured using a Gardener bubble viscometer.

17. A lacquer for use in electrical laminates comprising the curable composition as claimed in claim 9.

18. A thermoset composition, comprising: a reaction product of a homogeneous curable composition comprising a cyanate ester, an epoxy resin, and a maleimide component comprising at least one bismaleimide.

19. The thermoset composition of claim 18, wherein the maleimide component comprises a phenyl maleimide and a 4,4′-bismaleimido-diphenylmethane.

20. The thermoset composition of claim 19, wherein a weight ratio of the phenyl maleimide to the 4,4′-bismaleimido-diphenylmethane is in the range from 95:5 to 5:95.

21. The thermoset composition of claim 19, wherein a weight ratio of the phenyl maleimide to the 4,4′-bismaleimido-diphenylmethane is in the range from 25:75 to 75:25.

22. The thermoset composition of claim 18, wherein the cyanate ester component comprises at least one of a cyanate ester and a partially trimerized cyanate ester.

23. The thermoset composition of claim 18, wherein a molar ratio of the maleimide component to the epoxy resin to the cyanate ester component in the homogeneous solution is in the range from 90:5:5 to 5:90:5 to 5:5:90, wherein the molar ratio is based on the functional groups of the respective components.

24. The thermoset composition of claim 18, wherein a molar ratio of the maleimide component to the epoxy resin to the cyanate ester component in the homogeneous solution is in the range from 30:20:50 to 50:30:20 to 20:50:30, wherein the molar ratio is based on the functional groups of the respective components.

25. The thermoset composition of claim 18, wherein the thermoset composition has:
a glass transition temperature, as measured by differential scanning calorimetry, of at least 210° C.; and
a 5% decomposition temperature, as measured using thermal gravimetric analyses, of at least 300° C.

26. A composite comprising the thermoset composition as claimed in claim 18.

27. A process for forming a composite, comprising:
impregnating a first substrate with a curable composition, wherein the curable composition comprises:
a maleimide component comprising at least one bismaleimide;
a cyanate ester component; and
an epoxy resin;
wherein the curable composition is a homogeneous solution;
at least partially curing the curable composition to form a prepreg;
disposing the prepreg on a second substrate; and
curing the prepreg to form an electrical laminate.

28. The process of claim 27, wherein the second substrate is electrically conductive.

29. The process of claim 27, further comprising:
admixing the epoxy resin and the maleimide component comprising at least one bismaleimide at a temperature in the range from about 50° C. to about 250° C.;
admixing the cyanate ester component with the epoxy-maleimide admixture to form the curable composition.

30. The process of claim 27, wherein the curable composition, upon curing, has:
a glass transition temperature, as measured by differential scanning calorimetry, of at least 210° C.; and
a 5% decomposition temperature, as measured using thermal gravimetric analyses, of at least 300° C.
